(19) United States
(12) Patent Application Publication
(10) Pub. No.: US 2007/0046471 A1
(43) Pub. Date: Mar. 1, 2007

(54) RFID system for identifying electrodes

(76) Inventor: Shesh Nyalamadugu, Chula Vista, CA (US)

Correspondence Address: JAMES C WESEMAN;LAW OFFICES OF JAMES C WESEMAN, 401 WEST A STREET, SUITE 1600, SAN DIEGO, CA, 92101, US

(21) Appl. No.: 11/495,898

(22) Filed: Jul. 28, 2006

Related U.S. Application Data
(60) Provisional application No. 60/703,514, filed on Jul. 28, 2005.

(51) Int. Cl. G08B 13/14

(52) U.S. Cl. 340/572.1

(57) ABSTRACT

An RFID system for identifying electrodes that comprises at least one connector cable, wherein at least one of said connector cables has a plurality of antenna connectors. At least two of the antenna connectors will each have an RFID antenna attached thereto, and an RFID reader will be utilized having a power rating sufficient such that there is no substantial interference between the RFID antennas when the reader is activated.

### FIELD OF THE INVENTION

The present invention relates to the field of radio frequency identification (RFID) tagging and, more particularly, to an RFID system which identifies medical electrodes.

### BACKGROUND OF THE INVENTION

Radio frequency identification (RFID) tags and labels (collectively referred to herein as “devices”) are widely used to associate an object with an identification code. RFID devices generally have a combination of antennas and analog and/or digital electronics, which may include for example communications electronics, data memory, and control logic. For example, RFID tags are used in conjunction with security-locks in cars, for access control to buildings, and for tracking inventory and parcels.

As noted above, RFID devices are generally categorized as labels or tags. RFID labels are RFID devices that have a surface attached directly to an object, adhesively or otherwise. RFID tags, in contrast, are secured to objects by other means, for example by use of a plastic fastener, string, embedding of implantation, or other securing means.

RFID devices generally utilize an antenna structure that is operatively coupled to electrical or electronic components, in the form of a chip or a strap (such as is described in U.S. Pat. No. 6,606,247), to communicate with a receiver or transceiver device such as a detector or reader. The antenna structure utilizes conductive material arranged on a dielectric substrate in a suitable array. The antenna structure is coupled to the chip or strap to allow communication between the RFID device and the reader and the detector. A wide variety of antenna sizes, shapes, and configurations may be utilized to achieve various communication characteristics, depending on many factors.

The conductive material of the antenna structure may be attached on the dielectric substrate by any of a variety of suitable methods. One such method involves printing of a conductive ink to form the antenna structure. Such conductive inks may include any of a variety of suitable electrically conductive materials, including conductive metal particles, carbon particles, or conductive polymer particles.

RFID tagging is an emerging technology used for identifying, authenticating and tracking objects. RFID has become widely used in virtually every industry, including transportation, manufacturing, asset tracking, airline baggage tracking, and highway toll management. As opposed to more traditional technologies involving printed barcodes and line-of-sight scanning devices, the RF identification process involves the transmission and reception of radio waves between the tag, which contains the transponder, and the base station. The transponder comprises a semi-conductor chip comprised of RF circuits, logic and memory, and an antenna, which allows reception and transmission of radio waves by radiating or absorbing energy in a variety of bandwidths.

### DISCLOSURE OF THE INVENTION

The present invention meets the above needs by providing an RFID system which can identify electrodes. According to one aspect of the invention, an RFID system for identifying electrodes is provided that comprises at least one connector cable, wherein at least one of said connector cables has a plurality of antenna connectors. At least two of the antenna connectors will each have an RFID antenna attached thereto, and an RFID reader will be utilized having a power rating sufficient such that there is no substantial interference between the RFID antennas when the reader is activated.

### BRIEF DESCRIPTION OF THE DRAWINGS

FIG. 1 is a diagrammatic view of cabling system for connecting electrodes to the central recording system, in which 1A-1H are connectors used to connect the electrodes to the cables;

FIG. 2 is a diagrammatic view of the cabling system of FIG. 1, with reader antennas attached to it, in which 2A-2D are each a connector with a reader loop antenna connected to it;

FIG. 3 is a diagrammatic view of a sample electrode of the invention, wherein 3A and 3B are two connector pins. Electrode connectors are connected to these pins. An RFID tag is attached to this electrode, which is read by the reader antenna; and

FIG. 4 is diagrammatic view of the sample electrode of FIG. 3 with an RFID tag attached to it, wherein 4A is the tag. When a connector with a reader antenna is connected to the pin with the tag attached around it, it reads the identification information.

### DETAILED DESCRIPTION OF THE INVENTION

The present invention meets the above needs by providing an RFID system which can identify electrodes. According to one aspect of the invention, an RFID system for identifying electrodes is provided that comprises at least one connector cable, wherein at least one of said connector cables has a plurality of antenna connectors. At least two of the antenna connectors will each have an RFID antenna attached thereto, and an RFID reader will be utilized having a power rating sufficient such that there is no substantial interference between the RFID antennas when the reader is activated.

Certain types of medical equipment, such as impedance cardiogram (ICG) and electrocardiogram (ECG) devices, use electrodes that are attached to patients to take hemodynamic measurements in the body. These electrodes are connected to a monitoring system through cables. Disposable electrodes are attached to the body to make these measurements. In order to identify particular types of electrodes and to prevent recurring usage of electrodes, RFID technology can be used. RFID tags are placed on the electrodes to transmit identification information and to monitor their use.

To design an RFID system for such an application there are certain attributes that are to be considered. The RFID reader antenna should be small in order to fit into the electrode connector, and the read range is desirably short so that the tag in use does not interfere with other electrode tags.

Components of the Present System

In order to implement the present system, certain aspects of RFID antennas, RFID tags, electrode connectors and RFID readers constructed in accordance with the prior art may be utilized.

For example, RFID antennas can be constructed according to any means now known or developed in the future. In the typical RFID antenna, a non-conductive substrate can include any of a variety of suitable materials, such as a suitable polymeric material. Examples of suitable such materials include, but are not limited to, high Tg polycarbonate, poly(ethylene terephthalate), polyarylate, polysulfone, a norbornene copolymer, poly phenylsulfone, polyetherimide, polyethylenenaphthalate (PEN), polyethersulfone (PES), polycarbonate (PC), a phenolic resin, polyester, polyimide, polyetherester, polyetheramide, cellulose acetate, aliphatic polyurethanes, polyacrylonitrile, polytrifluoroethylenes, polyvinylidene fluorides, HDPEs, poly(methyl methacrylates), a cyclic or acyclic polyolefin, or paper, among others.

Conductive material used in the fabrication of the antenna can include any suitable conductive materials, such as suitable conductive inks. Such conductive inks may include inks with suitable conductive materials such as conductive metal or non-metal particles. Examples of suitable conductive materials include copper particles, nickel particles, silver particles, aluminum particles, various metal alloy particles, carbon particles, and conductive polymer particles. Examples of conductive polymers include intrinsically conductive polymers such as polyethylenedioxythiophene (PEDOT), polypyrrole (PPy), or polyaniline (PANI), among others.

Conductive inks may be selectively deposited to form the antenna structure by any of a variety of suitable processes, such as flexo printing, offset printing, and gravure printing. The resistance may be less than 100 ohms per square. (Resistivity is measured on a strip with a 10:1 length to width ratio. Ohmlsquare is determined by dividing the resistance measurement along the length by 10.) Of course, it will be appreciated that the choice of material may depend on such factors as cost and availability of conductive materials, and the level of conductivity required.

The antenna structure may also include conductive materials deposited in other ways, such as by electroplating, physical deposition, or chemical deposition. For example, a layer of copper may be deposited by such methods. Selective removal processes such as etching may be used to remove suitable portions of the deposited conductive material.

RFID transponders (also called labels or tags) are also utilized for tagging the electrodes. An RFID transponder generally comprises an RFID antenna and any of a variety of combinations of wireless communication devices (RFID chips) with conductive leads coupled thereto to facilitate electrical connection. Examples of suitable RFID chips include the Philips HSL chip, available from Philips Electronics, and the EM Marin EM4222, available from EM Microelectronic-Marin SA, as well as RFID chips available from Matrics Inc. of Columbia, Md. USA.

The RFID chip may be coupled to the antenna structure by any of a variety of suitable methods, such as, for example, by use of a conductive adhesive, by use of welding and/or soldering, or by electroplating.

It will be appreciated that the RFID device may have other layers and/or structures. For example, the RFID device may have an adhesive layer for use in adhering the RFID device to an object. The adhesive layer may have a peel layer thereupon for protecting the adhesive prior to use. The RFID device may also have other layers, such as protective layers, and/or a printable layer for printing information thereupon. It will be appreciated that the RFID device may also include additional suitable layers and/or structures, other than those mentioned herein.

To design an RFID system for electrode identification there are certain attributes that are to be considered. The RFID reader antenna should be small in order to fit into the electrode connector, and the read range is desirably short so that the tag in use does not interfere with other electrode tags.

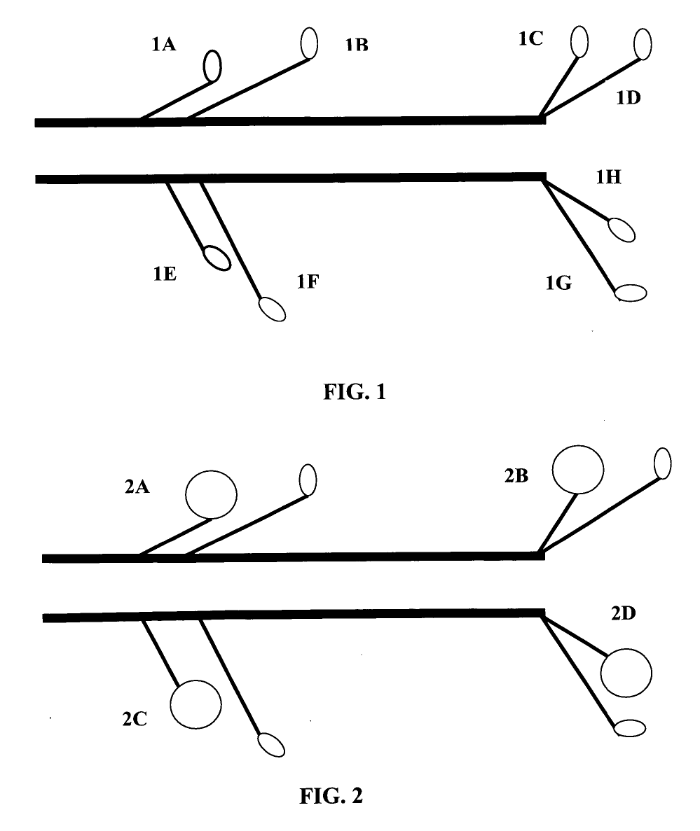

A small RFID reader antenna that can fit into the electrode connector is provided (FIG. 1). In a preferred embodiment, there will be at least one connector cable desirably having a plurality of branches, each having a plurality of electrode connectors. In the embodiment of FIG. 1, there is depicted four electrode connectors in each branch of the cable. Two antennas are connected to two of these electrode connectors and are then connected to a single reader (FIG. 2). This RFID reader communicates with the tag by sending an RF signal through the antennas. As there are multiple antennas connected to a single RFID reader, matching and tuning problems could occur. To overcome this difficulty, individual tuning and matching networks are used that are tuned simultaneously. A low power RFID reader is used in this application and its power is divided into the plurality of antennas resulting in reduced read range. Because of this feature, the reader antennas do not interfere with each other.

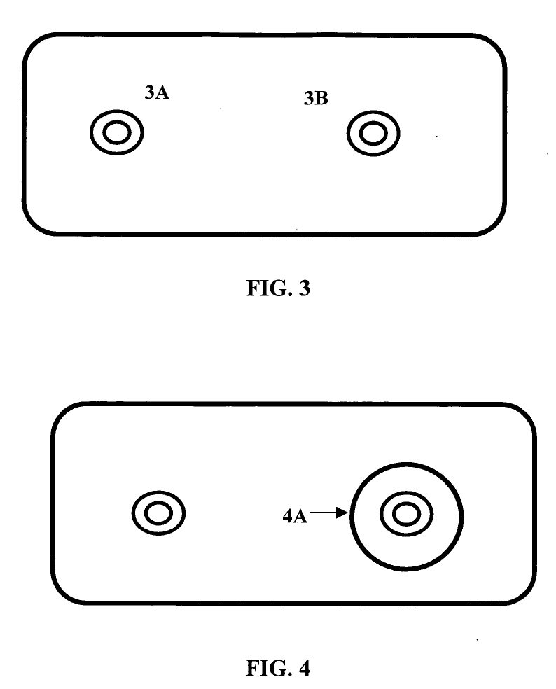

Each Electrode has two connector pins and two electrode connectors are attached each electrode. A reader antenna is placed on any one of the two electrode connectors. The tag is attached to the electrode as shown in the FIG. 3. When a connector with a reader antenna is attached to the electrode pin with the tag, it reads the identification information from the tag.

All patents and patent applications cited in this specification are hereby incorporated by reference as if they had been specifically and individually indicated to be incorporated by reference.

Although the foregoing invention has been described in some detail by way of illustration and Example for purposes of clarity and understanding, it will be apparent to those of ordinary skill in the art in light of the disclosure that certain changes and modifications may be made thereto without departing from the spirit or scope of the appended claims.

1. An RFID system for identifying electrodes comprising:
(a) at least one connector cable, wherein at least one of said connector cables having a plurality of antenna connectors;
(b) at least two of said antenna connectors each having an RFID antenna attached thereto; and
(c) an RFID reader having a power rating sufficient such that there is no substantial interference between said at least two RFID antennas when said reader is activated.

2. An RFID system for identifying electrodes as recited in claim 1 further comprising a plurality of electrodes at least two of which having an RFID tag thereon and capable of being detected by said RFID reader without substantial interference therebetween.

3. An RFID system for identifying electrodes as recited in claim 1 wherein said RFID reader comprising individual tuning and matching networks for the plurality of antennas attached to the reader.
